(19) United States
(12) Patent Application Publication
(10) Pub. No.: US 2002/0013159 A1
(43) Pub. Date: Jan. 31, 2002

(54) Portable radio device having a structure for improving antenna characteristic

(75) Inventors: Tsukasa Takahashi, Kawasaki-shi (JP); Masayoshi Hirai, Yokohama-shi (JP); Kenichi Yamada, Yokohama-shi (JP); Kazuhiko Ota, Yokohama-shi (JP); Yoshio Koyanagi, Ebina-shi (JP)

Correspondence Address: PEARNE & GORDON LLP, 526 SUPERIOR AVENUE EAST, SUITE 1200, CLEVELAND, OH, 44114-1484, US

(73) Assignee: Matsushita Electric Industrial Co., Ltd.

(21) Appl. No.: 09/903,945

(22) Filed: Jul. 12, 2001

(30) Foreign Application Priority Data
Jul. 14, 2000 (JP) P. 2000-214633

(51) Int. Cl. H04M 1/00

(52) U.S. Cl. 455/550; 455/90

(57) ABSTRACT

In a portable telephone, a main body case and a cover case are connected rotatably by a hinge portion. Further, the main body case is made of a resin material, metal, or a material including metal, and the cover case is made of a metal material. Further, when the portable telephone is used, the cover case is positioned on a side surface of an antenna. Therefore, the current becomes easy to flow, and the current flowing in the main body decreases. Accordingly, the disturbance of the current distribution in case that the main body case is held by the user's hand decreases, so that it is possible to reduce the deterioration of antenna gain.

### BACKGROUND OF THE INVENTION

The present invention relates to technology on a portable radio device having an antenna.

A portable radio device having an antenna performs radio communication (reception and transmission) by radiating an electromagnetic wave from the antenna, and antenna gain changes according to the radiation characteristic of antenna.

The radiation characteristic of antenna changes according to characteristics of antenna itself such as antenna shape, antenna length and impedance, and a set position of antenna in the portable radio device.

Regarding the set position of antenna, the antenna is frequently set at a position where obstacles to radio communication are as few as possible at its surroundings, for example, an upper end portion of a portable radio device. Thus setting the antenna at the upper end portion makes the radiation characteristic of antenna good.

Since the above antenna usually uses a λ/4 antenna, case current flows mach.

When a portable telephone is used in a state where a case is held by a hand of a user, the current distribution of the case is disturbed by influence of his hand, so that the antenna gain decreases.

### SUMMARY OF THE INVENTION

In view of this circumstance, an object of the invention is to improve antenna characteristic when a portable radio device having an antenna is really used.

In order to achieve the above object, a portable radio device having an antenna is characterized in that there are provided a first case connected to the antenna and a second case which is located on the side surface of the antenna when the portable radio device is used, and which is made of metal or a material including metal, and in that the first and second cases are connected to each other.

According to this portable radio device, when the portable radio device is used, the second case made of the metal material is positioned on the side surface of the antenna. Therefore, the current that has flown conventionally in the first case comes to flow also in the second case by electromagnetic connection,

Under the above state, the current that has flown conventionally in whole of the case is dispersed. In case of the above two cases, the current flows also in the second case, so that the current that has flown in the first case decreases. Accordingly, the disturbance of the current distribution in case that the first case is held by a hand of the user decreases, so that it is possible to reduce the deterioration of the antenna gain.

According to the second aspect of the invention, a portable radio device having an antenna is characterized in that there are provided a first case connected to the antenna and a second case which is located between the antenna and a user when the portable radio device is used, and which is made of metal or a material including metal, and in that the first and second cases are connected to each other.

According to this portable radio device, there is provided the second case which is located between the antenna and the user when the portable radio device is used, and which is made of metal or a material including metal, whereby the current that has flown conventionally in the first case flows also in the second case made of the metal material by the electromagnetic connection.

Accordingly, since the current that has flown in the first case decreases, the disturbance of the current distribution in case that the first case is held by a hand of the user decreases, so that it is possible to reduce the deterioration of the antenna gain.

According to the third aspect of the invention, a portable radio device is characterized in that there is provided a hinge portion for rotatably connecting the first and second cases to each other, and in that when the portable radio device is used, the first and second cases rotate about the hinge portion and stop at a predetermined angle that is smaller than 180 degrees.

According to this portable radio device, even in the foldable portable radio device having the hinge portion, when it is used, the second case is positioned near the antenna. Therefore, the current that has flown only in the first case flows also in the second case, and the disturbance of the current distribution in case that the first case is held by the user's hand decreases, so that it is possible to reduce the deterioration of the antenna gain.

According to the fourth aspect of the invention, a portable radio device is characterized in that the first case is a main body case in which a main substrate of the portable radio device is housed, and the second case is a cover case of the main body case.

According to this portable radio device, even if it is used in a state where the first case that is a main body case is held by the user's hand, since the current that has flown only in the first case flows also in the second case, the disturbance of the current distribution of the first case decreases, so that it is possible to reduce the deterioration of the antenna gain.

According to the fifth aspect of the invention, a portable radio device is characterized in that the second case is provided with a receiver portion that outputs sound.

According to this portable radio device, even if the receiver portion is put on the user's ear and the first case is held by his hand, since the current that has flown only in the first case flows also in the second case, the disturbance of the current distribution in the first case decreases, so that it is possible to reduce the deterioration of the antenna gain.

According to the sixth aspect of the invention, a portable radio device of according to any one of the first to fifth aspects is characterized in that the antenna includes a whip antenna that can be pulled out.

According to this portable radio device, even if it is used in a state where the whip antenna is pulled out and the first case is held by the user's hand, since the current that has flown only in the first case flows also in the second case, the disturbance of the current distribution in the first case decreases, so that it is possible to reduce the deterioration of the antenna gain.

### BRIEF DESCRIPTION OF THE DRAWINGS

FIG. 1 is a perspective view of the whole of a portable telephone.

FIG. 2 is a sectional view showing schematically the constitution of the portable telephone.

FIG. 3 is a current distribution diagram showing the current distribution of a case in a conventional portable telephone, in which FIG. 3A shows the current distribution of the case in case that an antenna is housed, and FIG. 3B shows the current distribution of the case in case that the antenna is extended.

FIG. 4 is a current distribution diagram of cases in a portable telephone according to this embodiment, in which FIG. 4A shows the current distribution of the cases in case that an antenna is housed, FIG. 4B shows the current distribution of the cases in case that the antenna is extended, FIG. 4C shows the current distribution of cases in case that an antenna having an angle is housed, and FIG. 4D shows the current distribution of the cases in case that the antenna having an angle is extended.

FIG. 5 is a diagram showing the improvement rate of antenna gain in the portable telephone.

### DETAILED DESCRIPTION OF THE PREFERRED EMBODIMENT

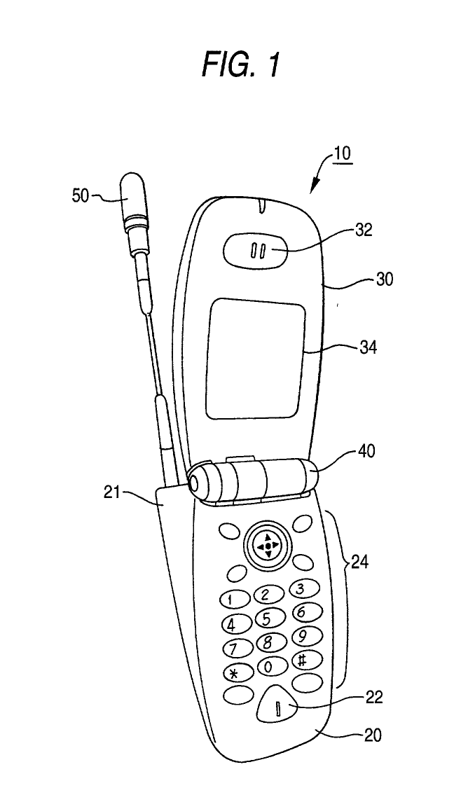

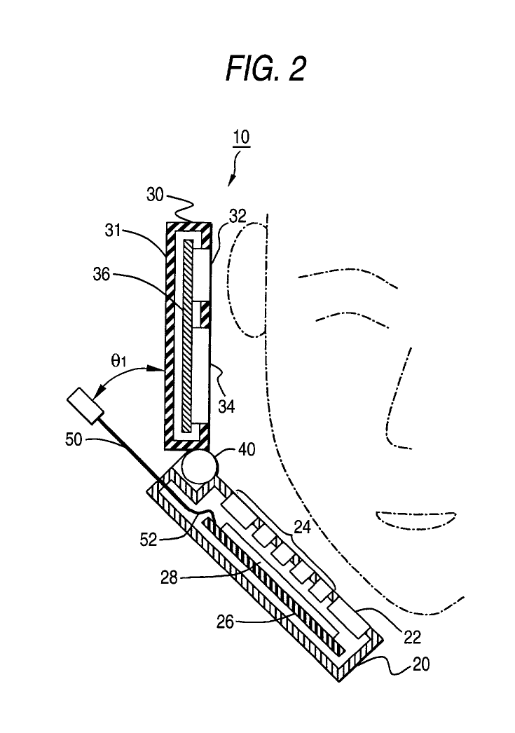

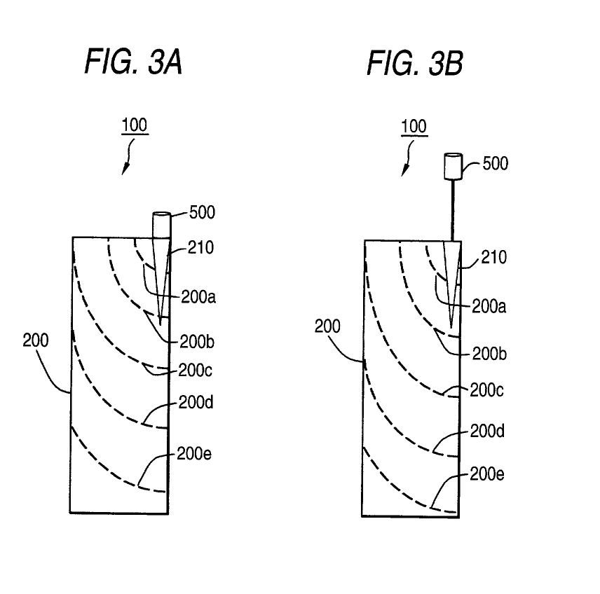

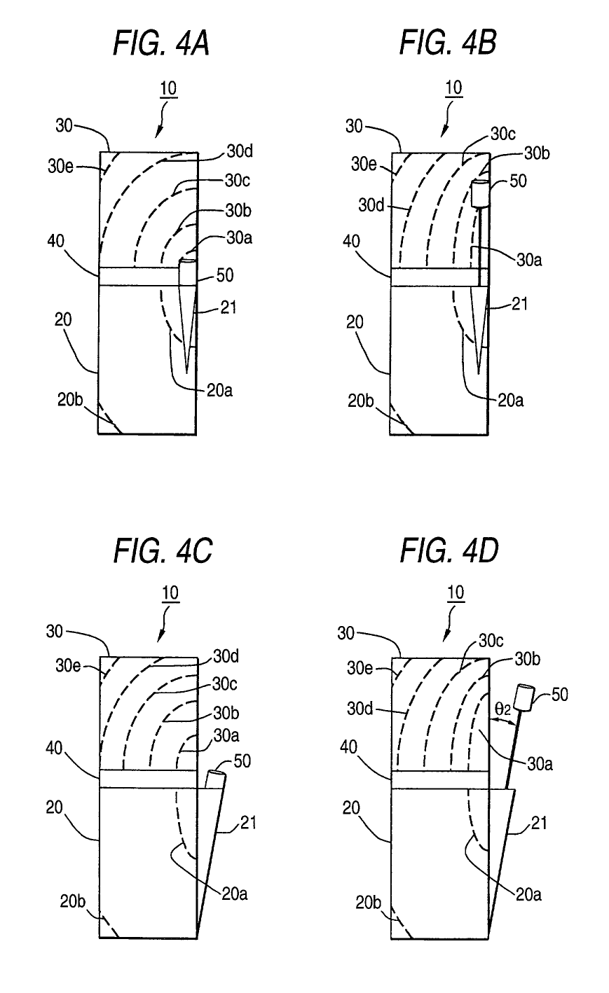

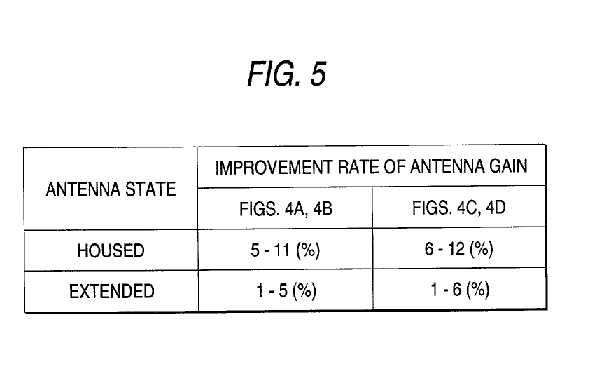

FIG. 1 is a perspective view of the whole of a portable telephone, FIG. 2 is a sectional view showing schematically the constitution of the portable telephone, FIG. 3 is a current distribution diagram of a case in a conventional portable telephone, FIG. 4 is a current distribution diagram of a case in a portable telephone according to this embodiment, and FIG. 5 is a diagram showing the improvement rate of antenna gain in the portable telephone.

Referring to FIGS. 1 and 2, the constitution of a portable radio device will be described.

Taking a portable radio device in this embodiment as a portable telephone 10 having a receiver of a receiving unit and a microphone of a transmission unit, the constitution will be described.

The portable telephone 10 comprises a main body case 20 (a first case), a cover case 30 (a second case) and a hinge portion 40 for rotatably connecting these cases to each other.

In the main body case 20, there are a microphone 22 that is a transmission unit for inputting voice made by a user of the portable telephone 10, and an operation key 24 including a power ON/OFF switch of the portable telephone 10, a ten key for inputting English characters and numerals, and a function key for selecting and executing various functions.

And, as a part of the main body case 20, there is provided an antenna-housing portion 21 in which an antenna 50 is housed.

Further, inside the main body case 20, there is a main substrate 26 on which electronic parts 28 such as a CPU for performing processing of various signals, a memory for recording various data and the like are mounted.

Further, a feeder 52 of the antenna 50 is connected to the main substrate 26.

Further, in the main body case 20, a comparatively heavy unit such as, for example, a power battery (not shown) is housed. Therefore, the center of gravity of the portable telephone 10 is located on the main body case 20 side. Accordingly, when the portable telephone 10 is used, the user holds the main body case 20 in his hand from a viewpoint of stability, so that the forceful power is not applied onto the hinge portion 40.

The cover case 30 is formed of metal or a material including metal, for example, magnesium. In the cover case 30, a receiver 32 that is a receiver unit through which the user of the portable telephone 10, hears the voice, a display portion 34 of the portable telephone 10, and a sub-substrate 36 through which these receiver 32 and display portion 34 are connected.

Further, the sub-substrate 36 is connected to the main substrate 26 by a flexible substrate (not shown), and the various electrical signals are transmitted and received between the substrates 36 and 26. Further, the flexible substrate is connected through the inside of the hinge portion 40 to the respective substrates.

The hinge portion 40 connects the main body case 20 and the cover case 30 to each other rotatably. When the portable telephone 10 is used, these cases can be kept opening at a predetermined angle, for example, as shown in FIG. 2, a predetermined angle that is smaller a little than 180 degrees.

FIG. 2 is a sectional view showing schematically the constitution of the portable telephone 10 in the using state.

The antenna 50, in this embodiment, is a whip antenna that can be extended and housed. When the antenna 50 is housed, it is housed in the antenna-housing portion 21 with its leading end portion remained.

Further, in the embodiment, when the antenna 50 is extended, as shown in FIG. 2, a predetermined angle θ₁ is formed by the antenna 50 and a reverse surface 31 of the cover case 30.

The foregoing is the whole constitution of the portable telephone 10.

Next, referring to FIGS. 3 and 4, a test result of current distribution of cases in a portable telephone 100 having an antenna 500 and in a portable telephone 10 having an antenna 50 will be described.

FIGS. 3 and 4 are current distribution diagrams showing the current distribution of the cases in the portable telephones 100 and 10. In these figures, the portable telephones 100 and 10 under the using state are viewed from the opposite side to the side opposed to the user and from the perpendicular direction of the main body cases 200 and 20.

Further, a dotted line drawn in each case is a line formed by connecting the same current values of the cases in the portable telephones 100, 10 (equivalent current line), and the close to the antennas 500, 50 the line is, the higher the current value is. Further, the absolute difference of the current values between the adjacent current lines is constant.

FIG. 3A, in the conventional portable telephone 100, shows the current distribution of the case in case that the antenna 500 is housed, and FIG. 3B, in the conventional portable telephone 100, shows the current distribution of the case in case that the antenna 500 is extended.

FIG. 4A, in the portable telephone 10 according to the embodiment, shows the current distribution of the case in case that the antenna 50 is housed in the antenna-housing portion 21, and FIG. 4B shows the current distribution of the case in case that the antenna 50 is extended.

FIG. 4C, in the portable telephone 10 according to the embodiment, shows the current distribution of the case in case that the antenna 50 is housed in the antenna-housing portion 21, and FIG. 4D shows the current distribution of the case in case that the antenna 50 is extended.

The antenna 50 in FIGS. 4C and 4D, as clear from FIG. 4D, when the portable telephone 10 is used, forms a predetermined angle θ₂ with the portable telephone 10 in the longitudinal direction, that is, with the long sides of the main body case 20 and cover case 30.

Turning to FIG. 3A, the antenna 500 is housed in an antenna housing portion 210. In the main body case 200, current is produced by the antenna 500, and equivalent current lines 200a, 200b, 200c, 200d, and 200e are produced. When current values of the respective current lines are taken as I(200a), I(200b), I(200c), I(200d) and I(200e), the current values become smaller in this order with the current value I(200a) as a maximum value.

Accordingly, the current flows from the equivalent current line 200a to the current line of which the current value is lower. Since the portable telephone 100 is used in a state where the main body case 200 is held by a hand of a user, the current distribution of the main case 200 has been disturbed and the antenna gain has decreased.

Next, referring to FIG. 3B, it is different from FIG. 3A in that the antenna 500 is pulled out. By pulling the antenna 500, the current distribution in the main body cover case 200 changes slightly. However, similarly to in FIG. 3A, in case that the portable telephone was used in a state where the main body case 200 is held by the user's hand, the current distribution of the main body case 200 has been disturbed and the antenna gain has decreased.

Next, referring to FIG. 4A, the current distribution of the case in the portable telephone 10 according to this embodiment will be described.

The antenna 50 is housed in the antenna-housing portion 21. In case that equivalent current lines are taken as 30a, 30b, 30c, 30d, and 30e in order close to the antenna 50 in the cover case 30, and current values of the respective current lines are taken as I(30a), I(30b), I(30c), I(30d), and I(30e), the current values become smaller in this order with the current value I(30a) as a maximum value.

Accordingly, the current produced by the antenna 50 flows from the equivalent current line 30a toward the equivalent current line 30e.

Further, in FIG. 4A, the current is produced also in the main body case 20 by the antenna 50, and equivalent current lines 20a and 20b are produced. The respective current values are I(20a) and I(20b), and the current values become smaller in this order with the current value I(20a) as a maximum value.

Accordingly, the current flows the equivalent current line 20a toward the equivalent current line 20b. However, the maximum current value I(20a) in the main body case 20 was lower than the maximum current value I(200a) of the main body case 200 in the conventional portable telephone 100.

This is because since the cover case 30 is made of a metal material such as magnesium, the current is easier to flow in the metal material than in a resin material.

Next, referring to FIG. 4B, it is different from FIG. 4A in that the antenna 50 is pulled out. By pulling the antenna 50, the current distribution of the cover case 30 changes slightly. However, similarly to in FIG. 4A, the maximum current value I(20a) of the main body case 20 was lower than the maximum current value I(200a) of the main body case 200 in the conventional portable telephone 100.

Accordingly, the amount of the current flowing in the main body case 20 becomes smaller than that of the current having flown in the conventional main body case 200. Therefore, even if the portable telephone 10 is used in a state where the main body case 20 is held by the user's hand, the disturbance of the current distribution of the main case 20 becomes small and the deterioration of antenna gain can be reduced.

Here, the improvement rate of antenna gain of the portable telephone 10, which was obtained by a test, is shown in FIG. 5.

The improvement rate of antenna gain in FIG. 5 shows the improvement rates of antenna gain of the portable telephones 10 in the embodiment shown in FIGS. 4A, 4B and FIGS. 4C, 4D on the basis of the antenna gain in the conventional portable telephone 100 shown in FIGS. 3A and 3B.

The comparison at the antenna housed is comparison between FIG. 3A and FIGS. 4A, 4C, and the comparison at the antenna extended is comparison between FIG. 3B and FIGS. 4B, 4D.

As shown in FIG. 5, in case that the antenna 50 in the portable telephone 10 shown in FIGS. 4A, 4B was housed, compared with the antenna in the conventional portable telephone, the antenna gain improved by 5-11(%) resultantly; and in case that the antenna 50 was extended, the antenna gain improved by 1-5(%) resultantly.

Further, as shown in FIG. 5, in case that the antenna 50 in the portable telephone 10 shown in FIGS. 4C, 4D was housed, compared with the antenna in the conventional portable telephone, the antenna gain improved by 6-12(%) resultantly, and in case that the antenna 50 was extended, the antenna gain improved by 1-6(%) resultantly.

In the description of the embodiment, the antenna 50 is a whip antenna that can be extended and housed. However, it may be a reverse F antenna that can be built in the main body case 20 or may be a diversity antenna by combination of the whip antenna and the reverse F antenna.

According to this portable radio device, when it is used, the second case made of the metal material is positioned on the side surface of the antenna. Therefore, the current that has flown conventionally in the first case comes to flow also in the second case by electromagnetic connection.

Under the above state, the current that has flown conventionally in the whole case of the portable radio device is dispersed, and in case of the above two cases, the current flows also in the second case, so that the current that has flown in the first case decreases. Accordingly, the disturbance of the current distribution in case that the first case is held by the user's hand decreases, so that it is possible to reduce the deterioration of antenna gain.

What is claimed is:

1. A portable radio device having an antenna, comprising:
a first case connected to the antenna; and
a second case which is connected to the first case and is made of metal or a material including metal,
wherein the second case is located on the side surface of the antenna when the portable radio device is used.

2. The portable radio device according to claim 1, further comprising a hinge portion for rotatably connecting the first case and the second case to each other,
wherein the first and second cases rotate about the hinge portion and stop at a predetermined angle that is smaller than 180 degrees when the portable radio device is used.

3. The portable radio device according to claim 2, wherein the first case is a main body case in which a main substrate of a portable radio device is housed, and the second case is a cover case of the main body case.

4. The portable radio device according to claim 1, wherein the second case includes a receiver portion that outputs sound.

5. The portable radio device according to claim 1, wherein the antenna includes a whip antenna that can be pulled out.

6. A portable radio device having an antenna, comprising:
a first case connected to the antenna; and
a second case which is connected to the first case, and is made of metal or a material including metal,
wherein the second case is located between the antenna and a user when the portable radio device is used.

7. The portable radio device according to claim 6, further comprising a hinge portion for rotatably connecting the first and second cases to each other,
wherein the first and second cases rotate about the hinge portion and stop at a predetermined angle that is smaller than 180 degrees when the portable radio device is used.

8. The portable radio device according to claim 7, wherein the first case is a main body case in which a main substrate of a portable radio device is housed, and the second case is a cover case of the main body case.

9. The portable radio device according to claim 6, wherein the second case includes a receiver portion that outputs sound.

10. The portable radio device according to claim 6, wherein the antenna includes a whip antenna that can be pulled out.
